(19) United States
(12) Patent Application Publication
(10) Pub. No.: US 2021/0080936 A1
(43) Pub. Date: Mar. 18, 2021

(54) METHODS AND SYSTEMS FOR MACHINING METAL PANELS

(71) Applicant: A. Zahner Company, Kansas City, MO (US)

(72) Inventors: L. William Zahner, III, Kansas City, MO (US); Joseph M. Kamm, Kansas City, MO (US)

(73) Assignee: A. Zahner Company, Kansas City, MO (US)

(21) Appl. No.: 16/572,864

(22) Filed: Sep. 17, 2019

(51) Int. Cl. G05B 19/418; G05B 19/4093; B23Q 15/14

(52) U.S. Cl. CPC G05B 19/4188; G05B 19/40937; G05B 2219/35002; G05B 19/4183; G05B 2219/35026; B23Q 15/14

(57) ABSTRACT

A method of machining a metal panel to impart a 2-dimensional representation of an image and a 3-dimensional representation of a dimensional design on the metal panel. An image file is received and converted to at least one image control file. A dimensional design file is received and converted to at least one dimensional design control file. The metal panel is then machined in accordance with the image control file to transfer the representation of the image on the metal panel and machined in accordance with the dimensional design control file to transfer the representation of the dimensional design on the metal panel adjacent to the representation of the image.

### BACKGROUND OF THE INVENTION

### 1. Field of the Invention

The present invention relates to metal panels for cladding building surfaces, creating art installations, and other applications. More particularly, the present invention relates to methods and systems for machining metal panels to create representations of images and designs on the panels.

### 2. Description of Related Art

Metal panels are often used to clad buildings and other structures and to create works of art. Such panels are often machined or otherwise manipulated to punch holes and/or indentations in the panels and/or to create textures or finishes on the panels for aesthetic purposes. Unfortunately, prior art methods and systems for machining metal panels for aesthetic purposes can't efficiently and accurately create complicated designs on the panels.

### SUMMARY OF THE INVENTION

The present invention provides improved methods and systems for machining metal panels for aesthetic purposes. In one embodiment, a method is provided for machining a metal panel to impart both a 2-dimensional representation of an image and a 3-dimensional representation of a dimensional design on the panel.

The method first receives an image file for an image. The image may be a photograph, a drawing, a geometric design, or any other artwork and may be obtained and converted to the image file by a camera, a scanner, a computer system, or any other electronic device. The image file is preferably provided in a common file format.

In some embodiments, the image file is then converted to a raster file or other intermediate file comprising a series of marks that vary in size according to the image. The marks are associated with markings, such as indentations, bumps, and/or holes, that will be transferred to the metal panel in order to create the representation of the image. The raster file may be scaled so the 2-dimensional representation of the image substantially covers the metal panel and/or several metal panels and so it doesn't interfere with the 3-dimensional representation of the dimensional design.

In some embodiments, the raster file may be manipulated to adjust the marks to accommodate features of a building surface to be covered by the metal panel and/or account for edges of the metal panel and so it doesn't interfere with the 3-dimensional representation of the dimensional design. These steps may be done either manually by an artist or automatically by a processor or other computing element.

The raster file is then converted to at least one image control file that may be used to directly or indirectly control the operation of a laser cutting machine, hole punching machine, or other metal machining equipment to transfer a representation of the image on a metal panel.

The method also receives a dimensional design file for a dimensional design. As with the image, the dimensional design may be a photograph, a drawing, a geometric design, or any other artwork and may be obtained and converted to the dimensional design file by a camera, a scanner, a computer system, or any other electronic device. The main difference between the image and the dimensional design is that the image is used to create a 2-dimensional representation on the metal panel, whereas the dimensional design is used to create a 3-dimensional representation on the metal panel.

In some embodiments, the dimensional design file is converted to an intermediate file and scaled and manipulated in the same manner as the raster file for the image. The dimensional design file, or its corresponding intermediate file, is then converted to one or more dimensional design control files that may be used to directly or indirectly control the operation of a laser cutting machine, hole punching machine, or other metal machining equipment to transfer a representation of the dimensional design on a metal panel.

In some embodiments, the image file and the dimensional design file are separate files, but in other embodiments, the files may be combined. Likewise, in some embodiments, the image control file and dimensional design control file are separate files, but in other embodiments, the files may be combined. For example, one drawing may include the image and another drawing may include the dimensional design, or a single drawing may include an image that is converted to an image control file and a dimensional design that is converted to a dimensional design control file.

The image control file and dimensional design control file are then transferred to at least one laser cutting machine, hole punching machine, or other metal machining equipment, or to a control system for such a machine, to instruct the metal machining equipment to create a 2-dimensional representation of the image and a 3-dimensional representation of the dimensional design on the metal panel.

The metal machining equipment creates the 2-dimensional representation on the panel by cutting holes or other markings on the panel in selected locations. For example, if the image is a photograph or drawing of a human face, various-sized holes may be laser cut, punched, or otherwise formed in the metal panel to create a 2-dimensional representation of the face on the metal panel.

Creation of the 3-dimensional representation involves several steps. First, the dimensional design control file instructs the metal machining equipment to cut a partial outline of the dimensional design on the metal panel. For example, if the dimensional design is a drawing of a butterfly, a partial outline of the butterfly may be laser cut or otherwise formed in the metal panel. The dimensional design control file also instructs the metal machining equipment to create at least one hinge or zone of weakness adjacent the outline. For example, a hinge may be created where the outline of the butterfly's wings meets the outline of the butterfly's body. Next, the metal machining equipment pushes or pulls portions of the metal panel inside the outline about the hinge to lift or depress them relative to the remainder of the panel. For example, portions of the metal panel inside the outline of the butterfly's wings may be pushed and/or pulled to lift and/or depress the butterfly's wings relative to the remainder of the metal panel. This creates a 3-dimensional representation of the butterfly on the metal panel.

Importantly, the portions of the metal panel that constitute the dimensional design may be lifted or depressed at any desired angles to create a desired 3-D effect. Moreover, some of the metal portions may be lifted or depressed more than other portions to create a variable 3-D effect. The 3-D representation of the dimensional design may also be created on the panel at numerous coordinates, in different sizes, and in a random, non-uniform fashion to create a mosaic-like design on the metal panel.

In some embodiments, the portions of the metal panel that constitute the dimensional design may be etched, textured, plated, or otherwise finished to create a contrast between the representations of the dimensional design and the remainder of the metal panel. Alternately, the portions of the metal panel outside the outlines of the dimensional design may be etched, textured, plated, or otherwise finished to create the contrast.

The metal panel and other metal panels machined in a similar manner may then be attached to a building as cladding and/or installed as artwork.

### BRIEF DESCRIPTION OF THE DRAWINGS

Embodiments of the invention are described in more detail below with reference to the attached drawing figures, wherein:

FIG. 1 is a schematic diagram of computer equipment and metal machining equipment that may be used to implement embodiments of the invention;

FIG. 2 is flow chart depicting exemplary steps of a method of the present invention.

FIG. 3 is an isometric view of a metal panel on which a 2-dimensional representation of an image and a 3-dimensional representation of a dimensional design has been created in accordance with embodiments of the present invention.

FIG. 4 is an enlarged, fragmentary, isometric view of a portion of the metal panel showing some of the 3-dimensional representations in more detail.

### DETAILED DESCRIPTION OF EMBODIMENTS OF THE INVENTION

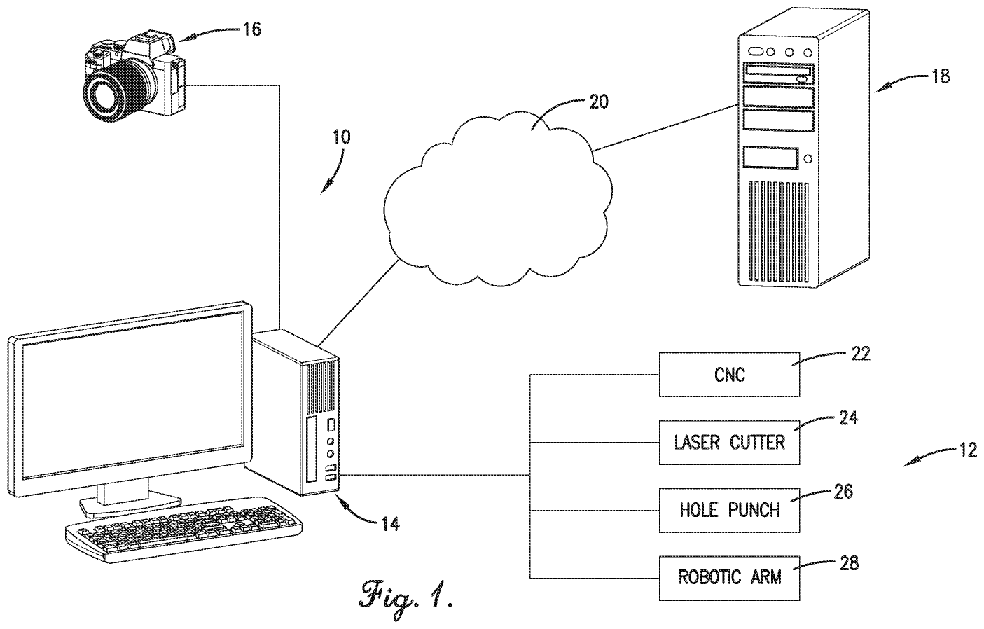

Embodiments of the present invention are implemented with one or more computers that are programmed to perform the functions described herein and one or more metal machining equipment that operate in accordance with instructions provided by the computers. In particular embodiments, the present invention is implemented with the computer equipment 10 and metal machining equipment 12 depicted in FIG. 1.

The computer equipment 10 may include a computer 14 operated by an architect, artist, designer, builder, etc.; a camera 16 for providing image files and dimensional design files to the computer 14; and a remote computer system 18 accessible by the computer 14 via the Internet or other network 20 for storing image files, dimensional design files, and other files and information. The computer equipment 10, and especially the computer 14, is programmed to perform the steps of the present invention and to run computer aided design or drafting (CAD) software. Aspects of the present invention may even be incorporated into CAD software. For example, some aspects of the invention may be performed in the CAD software, with other aspects being performed outside the CAD software. As such, the programs of the present invention may be a supplement added to the CAD software or may simply use a CAD file generated by the CAD software and be completely independent of the CAD software.

The metal machining equipment 12 may include a CNC machine 22, a laser cutting machine 24, a hole punching machine 26, a robot 28 with an extendible arm or ram, and/or any other machinery that can perform some of the steps described herein. In some embodiments, multiple metal machining equipment are provided to machine the metal panels, while in other embodiments, all machining is performed by a single machine.

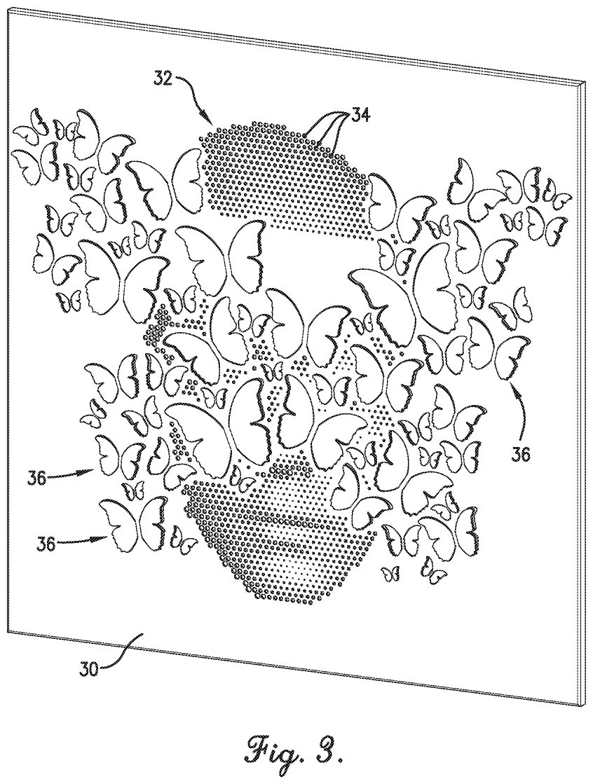

The metal panels that are machined in accordance with the present invention may be any size and shape and made of any metal materials or similar materials. If used to clad the exterior of a building, or for outdoor art, the panels are preferably made of a metal that resists corrosion, such as copper, aluminum, brass, or stainless steel. The metal panels are preferably small enough to be efficiently manipulated while large enough to minimize the number of panels needed to cover a building surface. The panels are preferably rectangular but may be other shapes. One exemplary metal panel 30, after it has been machined in accordance with aspects of the present invention, is shown in FIG. 3.

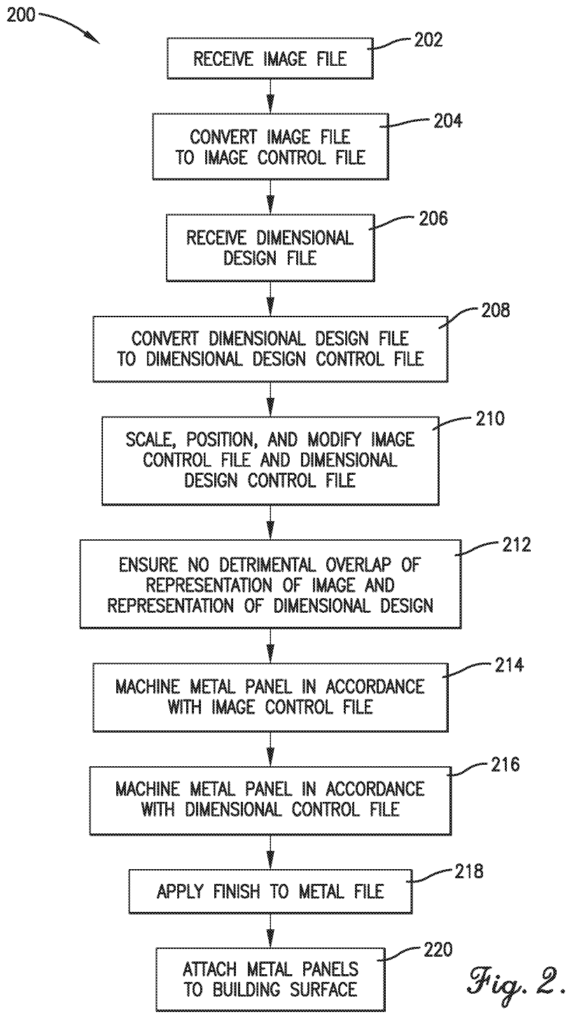

The flow chart of FIG. 2 shows the functionality and operation of embodiments of the invention. Some of the blocks of the flow chart may represent steps in a method 200 and/or module segments or portions of code of a program or programs used to implement aspects of the invention. Each program of the invention comprises one or more executable instructions for implementing logical function in the computer equipment 10. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

The method 200 includes the step of receiving an image file in the computer equipment 10 as depicted in block 202. The image file is a digital representation of an image. The image may be a photograph, a drawing, a geometric design, or any other image. The image may be obtained and converted to the image file by the camera, a scanner, or any other electronic device, and the image file may then be provided to the computer. The camera or other source of the image file may be directly wired or wirelessly connected to the computer or may be connected to the computer through a network. Alternatively, the image file may be stored on a removable memory device and transferred to the computer, may be created on the computer itself, or retrieved from the remote computer system.

In some embodiments, the image file is then converted to a raster file or other intermediate file by the computer. The raster file may comprise a series of marks that vary in size according to the image. The marks are associated with markings, such as indentations, bumps, and/or holes, that will be transferred to the metal panel in order to create the representation of the image. An architect or other person may scale the raster file so the representation of the image substantially covers the metal panel and/or several metal panels and so it doesn't interfere with the representation of the dimensional design. Such scaling may be done automatically by one or more programs on the computer or may be done under the direction of an architect or artist operating the computer.

In some embodiments, the raster file may be manipulated to move, re-arrange, or otherwise modify the marks to accommodate features of a building surface to be covered by the metal panel and to ensure the 2-D representation doesn't interfere with the 3-D representation. The marks may also be moved and/or modified to accommodate edges of the metal panel. Such manipulations may be performed either manually by an artist or automatically by programs on the computer or other computing elements.

The raster file, or the image file if no separate raster file is created, is then converted to at least one image control file as depicted in block 204. The image control file is used to directly or indirectly control the operation of the metal machining equipment 12 to transfer a representation of the image or one or more metal panels.

Particular ways to implement some of the steps in blocks 202 and 204, including converting the image file to a raster file, scaling the raster file, manipulating the marks, and converting the raster file to an image control file, are disclosed in U.S. Pat. No. 7,212,688, which is incorporated into the present application in its entirety by reference. However, the image, image file, intermediate file, and image control file may be created, converted, and manipulated in other ways without departing form the scope of the present invention.

The method 200 also includes the step of receiving a dimensional design file in the computer equipment 10 as depicted in block 206. The dimensional design file is a digital representation of a dimensional design. As with the image, the dimensional design may be a photograph, a drawing, a geometric design, or any other artwork and may be obtained and converted to the dimensional design file by the camera, a scanner, or any other computing or electronic device. The dimensional design file may also be created with the computer itself or retrieved form the remote computer system. The dimensional design differs from the image in that it's used to create a 3-dimensional representation on the metal panel, whereas the image is used to create a 2-dimensional representation on the metal panel as discussed in more detail below. In some embodiments, the dimensional design file is provided separately from the image file, and in other embodiments the files are provided or created together.

In some embodiments, the computer converts the dimensional design file to an intermediate file. The intermediate file may then be manipulated by an architect or artist for scaling purposes and to coordinate the relative placement of the 3-dimensional representation and the 2-dimensional representation on the metal panel. Such scaling and positioning may be done automatically by one or more programs on the computer or under the direction of an architect or artist operating the computer.

The computer then converts the intermediate file, or the dimensional design file itself if no separate intermediate file is created, to one or more dimensional design control files as depicted in block 208. The dimensional design control file may be used to directly or indirectly control the operation of the metal machining equipment 12 by providing coordinates and other instructions for cutting a partial outline of the dimensional design in the metal panel. The dimensional design control file also provides instructions for creating at least one hinge or zone of weakness adjacent the partial outline. For example, if the dimensional design is a drawing of a butterfly, the dimensional design control file provides instructions for cutting a partial outline of the butterfly in the metal panel and instructions for creating at least one hinge or other zone of weakness adjacent the outline. The dimensional design control file also provides instructions for lifting depressing portions of the metal panel as described below.

The computer then scales or modifies the image control file and dimensional design control file as needed to fit the panel and to avoid interference between the 2-dimensional representation and the 3-dimensional representation as depicted in blocks 210 and 212. As mentioned above, the image control file includes coordinates for holes that form the representation of the image, and the dimensional design control file includes coordinates for the outlines and hinges of the dimensional design representation. The computer compares these coordinates to detect overlaps or other interferences. If interferences are detected, the computer adjusts either the image control file or the dimensional design control or both. For example, if the computer detects that a hole is programmed to be drilled in the metal panel at the same coordinate as a hinge, the computer either moves the coordinates for the hole so it no longer interferes with the coordinates for the hinge, moves the hinge, or both. In one embodiment, if the computer detects such an interference, it simply eliminates the hole. In another embodiment, if the computer detects such an interference, it adjusts the coordinates for the entire dimensional design until the interference is eliminated.

After the image control file and dimensional design control file have been created and reconciled to avoid interferences as described above, the files are then transferred to the metal machining equipment or to a control system for the machinery. The metal machining equipment 12 then machines at least one metal panel in accordance with the image control file to create a 2-dimensional representation of the image 32 on the metal panel as depicted in block 214. For example, if the image is a photograph or drawing of a human head, various-sized holes 34 may be laser cut, punched, or otherwise formed in the metal panel to create a 2-dimensional representation of the head on the metal panel as shown in FIG. 3.

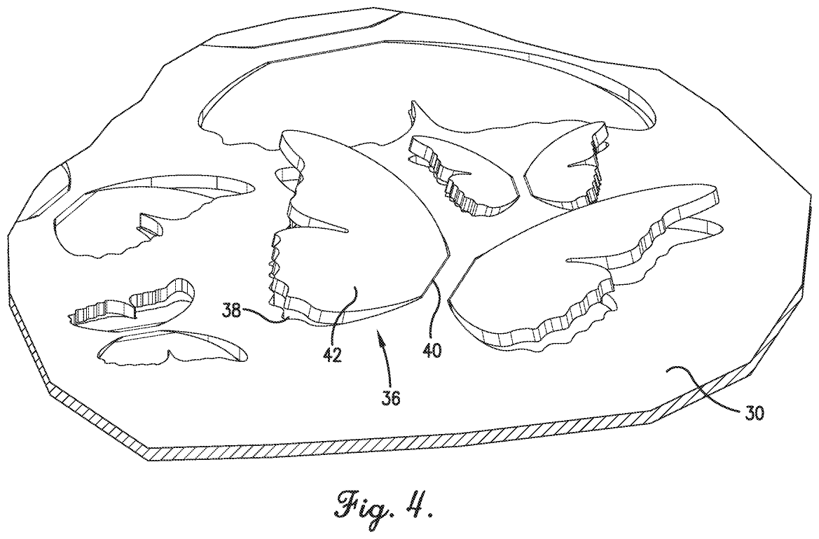

The metal machining equipment 12 then machines the metal panel in accordance with the dimensional design control file to create a 3-dimensional representation of the dimensional design 36 on the metal panel adjacent to the 2-dimensional representation as depicted in block 216. Creation of the 3-dimensional representation involves several steps. First, the dimensional design control file instructs one of the metal machining equipment 12 to cut a partial outline of the dimensional design on the metal panel. For example, if the dimensional design is a drawing of a butterfly, a partial outline 38 of the butterfly may be laser cut or otherwise formed in the metal panel as shown in FIG. 4. The dimensional design control file also instructs the metal machining equipment to create at least one hinge or other zone of weakness adjacent the outline. For example, a hinge 40 may be created where the outline of the butterfly's wings meets the butterfly's body. Next, the metal machining equipment or another machine pushes or pulls portions of the metal panel inside the outline about the hinge to lift or depress them relative to the remainder of the panel. For example, portions of the metal panel inside the outline of the butterfly's wings 42 may be pushed and/or pulled to lift and/or depress the butterfly's wings relative to the remainder of the metal panel as shown in FIG. 4. This creates a 3-dimensional representation of the butterfly on the metal panel as shown in FIG. 4.

In some embodiments, the metal panel passes between two robots or other metal machining equipment, one of which pushes the cut portions of the metal panel from one side and the other of which pushes the cut portions of the metal panel from the opposite side. When the dimensional design is a butterfly, this creates a representation with some butterfly wings extending out one side of the metal panel and other butterfly wings extending out the opposite side of the panel as shown in FIG. 4.

The computer may also be programmed to determine the distance the representation of the dimensional design can be pushed or pulled without breaking or weakening the hinge and to provide corresponding instructions to the metal machining equipment via the dimensional design control file. The computer may also be programmed to determine the amount of force necessary to push and/or pull the portions of the metal panel a specified distance and to provide corresponding instructions to the metal machining equipment via the dimensional design control file.

Importantly, the portions of the metal panel that constitute the dimensional design may be lifted or depressed at any desired angles to create a desired 3-D effect. Moreover, portions of the 3-dimensional representation may be lifted or depressed more than other portions to create a variable 3-D effect. The representation of the dimensional design may also be repeated on the panel at numerous coordinates and in various non-uniform sizes to create a mosaic-like design on the metal panel as shown in FIG. 3.

In some embodiments, the portions of the metal panel inside the outline of the dimensional design may be etched, textured, plated, or otherwise finished to create a contrast between the representations of the dimensional design and the remainder of the metal panel as depicted in block 218. Alternately, the portions of the metal panel outside the outlines of the dimensional design may be etched, textured, plated, or otherwise finished to create the contrast.

The machining of the metal panel to create the 3-dimensional representation of the dimensional design may be performed after, before, or at the same time as the machining steps that create the 2-dimensional representation of the image. Moreover, the machining steps may be performed on one or multiple metal machining equipment. In one embodiment, the 2-dimensional representation of the image is first laser-cut or otherwise formed on the metal panel by a first metal machining equipment, then the metal panel is transferred either automatically or manually to a second metal machining equipment laser cut or otherwise form the 3-dimensional representation of the dimensional design on the metal panel adjacent the 2-dimensional representation of the image, then the metal panel is transferred either automatically or manually to a third metal machining equipment to lift or depress portions of the 3-dimensional representation of the dimensional design to lift or depress them relative to the remainder of the panel, then the metal panel is transferred either automatically or manually to another metal machining equipment to etch, texture, plate, or otherwise finish portions of the metal panel to create a contrast between the representations of the dimensional design and the remainder of the metal panel.

The metal panel and other metal panels machined in a similar manner may then be attached to a building as cladding and/or artwork as depicted in block 220. The flanges of the metal panels may be welded, bolted, or otherwise attached together. In this manner, the representation of the image is transferred to the building 14.

The above-described steps can be performed in different orders, and/or some of the steps can even be combined. For example, the image and the dimensional design may be provided in a single digital file rather than separate files. And the representation of the dimensional design may be machined on the panel before, after, or at the same time as the representation of the image.

Additionally, while the tasks and processes described herein have been described as being performed by the program, selected ones of those processes may in fact be performed by more than one program or independent process.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the computer may comprise dedicated circuitry or logic that is permanently configured, such as an application-specific integrated circuit (ASIC), or indefinitely configured, such as an FPGA, to perform certain operations. The computer may also comprise programmable logic or circuitry (e.g., as encompassed within a general-purpose processor or other programmable processor) that is temporarily configured by software to perform certain operations. It will be appreciated that the decision to implement the computer as special purpose, in dedicated and permanently configured circuitry, or as general purpose (e.g., configured by software) may be driven by cost and time considerations.

Accordingly, the terms “computer”, “processing element”, or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the computer is temporarily configured (e.g., programmed), each of the processing elements need not be configured or instantiated at any one instance in time. For example, where the computer comprises a general-purpose computer configured using software, the general-purpose processor may be configured as respective different processing elements at different times. Software may accordingly configure the computer to constitute a hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more computers or other processing elements that are temporarily configured (e.g., by software) or permanently configured to perform the relevant operations. Whether temporarily or permanently configured, such computers or other processing elements may constitute processing element-implemented modules that operate to perform one or more operations or functions. The modules referred to herein may, in some example embodiments, comprise processing element-implemented modules.

Similarly, the methods or routines described herein may be at least partially computer-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described a preferred embodiment of the invention, what is claimed as new and desired to be protected by Letters Patent includes the following:

1. A method of machining a metal panel to impart a 2-dimensional representation of an image and a 3-dimensional representation of a dimensional design on the metal panel, the method comprising:
receiving an image file for the image;
converting the image file to at least one image control file;
receiving a dimensional design file for the dimensional design;
converting the dimensional design file to at least one dimensional design control file;
machining the metal panel in accordance with the image control file to transfer the representation of the image on the metal panel; and
machining the metal panel in accordance with the dimensional design control file to transfer the representation of the dimensional design on the metal panel adjacent to the representation of the image.

2. The method as set forth in claim 1, wherein the machining the metal panel in accordance with the image control file step comprises cutting the metal panel with a cutting machine to transfer the representation of the image on the metal panel.

3. The method as set forth in claim 1, wherein the machining the metal panel in accordance with the image control file step comprises perforating the metal panel with a perforating machine to transfer the representation of the image on the metal panel.

4. The method as set forth in claim 1, wherein the machining the metal panel in accordance with the dimensional design control file step comprises cutting an outline of the dimensional design into the metal panel to transfer the representation of the dimensional design on the metal panel.

5. The method as set forth in claim 4, wherein the cutting an outline of the dimensional design into the metal panel step further comprises creating a hinge adjacent the outline.

6. The method as set forth in claim 5, wherein the machining the metal panel in accordance with the dimensional design control file step further comprises pushing and/or pulling portions of the metal panel inside the outline so as to depress or lift portions of the representation of the dimensional design relative to the hinge.

7. The method as set forth in claim 1, further comprising the step of applying a finish to the representation of the dimensional design on the metal panel to provide a contrast with portions of the metal panel not occupied by the dimensional design.

8. The method as set forth in claim 1, further comprising the step of applying a finish to portions of the metal panel not occupied by the dimensional design so as to provide a contrast with the representation of the dimensional design on the metal panel.

9. The method as set forth in claim 1, further comprising the step of attaching the metal panel to a building surface or art installation.

10. A method of machining a metal panel to impart a 2-dimensional representation of an image and a 3-dimensional representation of a dimensional design on the metal panel, the method comprising:
receiving an image file for the image;
converting the image file to an intermediate file comprising a series of marks that vary according to the image;
manipulating the intermediate file to accommodate features of a building surface to be covered by the metal panel;
converting the intermediate file to at least one image control file;
receiving a dimensional design file for the dimensional design;
converting the dimensional design file to at least one dimensional design control file;
cutting the metal panel in accordance with the image control file to transfer the representation of the image on the metal panel; and
cutting an outline of the dimensional design on the metal panel while leaving a hinge in the outline in accordance with the dimensional design control file to transfer the representation of the dimensional design on the metal panel; and
pushing portions of the metal panel inside the outline so as to depress portions of the representation of the dimensional design relative to the hinge;
pulling other portions of the metal panel inside the outline so as to lift portions of the representation of the dimensional design relative to the hinge.

11. The method as set forth in claim 10, wherein the cutting step comprises cutting holes into the metal panel with a cutting machine to transfer the representation of the image on the metal panel.

12. The method as set forth in claim 10, wherein the cutting step comprises perforating the metal panel with a perforating machine to transfer the representation of the image on the metal panel.

13. The method as set forth in claim 10, wherein the cutting the outline step comprises cutting an outline of the dimensional design into the metal panel with a cutting machine to transfer the representation of the dimensional design on the metal panel.

14. The method as set forth in claim 13, wherein the cutting the outline step further comprises creating a hinge adjacent the outline.

15. The method as set forth in claim 14, further comprising the step of

16. The method as set forth in claim 10, further comprising the step of applying a finish to the representation of the dimensional design on the metal panel to provide a contrast with portions of the metal panel not occupied by the dimensional design.

17. The method as set forth in claim 10, further comprising the step of applying a finish to portions of the metal panel not occupied by the dimensional design so as to provide a contrast with the representation of the dimensional design on the metal panel.

18. The method as set forth in claim 10, further comprising the step of attaching the metal panel to the building surface.

19. The method as set forth in claim 10, wherein the image control file and the dimensional design control file are combined in a single composite control file.
